(19) United States
(12) Patent Application Publication
(10) Pub. No.: US 2026/0186972 A1
(43) Pub. Date: Jul. 2, 2026

(54) PROCESSOR WITH NON-STANDARD SECTOR SIZE AND OPERATING METHOD THEREOF

(71) Applicant: RESEARCH & BUSINESS FOUNDATION SUNGKYUNKWAN UNIVERSITY, Suwon-si (KR)

(72) Inventors: Jungrae KIM, Suwon-si (KR); SoYoung Park, Suwon-si (KR); Hojung Namkoong, Suwon-si (KR)

(21) Appl. No.: 19/349,655

(22) Filed: Oct. 3, 2025

(30) Foreign Application Priority Data
Oct. 7, 2024 (KR) 10-2024-0136063

(51) Int. Cl. G06F 12/0846

(52) U.S. Cl. CPC G06F 12/0846; G06F 2212/604

(57) ABSTRACT

A processor may include a memory controller and a cache memory. The memory controller, during a write operation to a main memory, generates a B-byte sized parity for A-byte sized data, stores the A-byte sized data and the B-byte sized parity through a single write command, and during a read operation from the main memory, reads the A-byte sized data and the B-byte sized parity through a single read command, performs error correction on the A-byte sized data based on the B-byte sized parity, and then transfers only the A-byte sized data to a cache memory. The cache memory receives the A-byte sized data from the memory controller or transmits the A-byte sized data to the memory controller, and includes at least one cache line that stores a plurality of an A-byte sized data.

### CROSS-REFERENCE TO RELATED APPLICATION

This application claims priority to Korean Patent Application No. 10-2024-0136063, filed on Oct. 7, 2024, the entirety of which is incorporated herein by reference for all purposes.

### TECHNICAL FIELD

The present invention relates to a data processing technology for a processor to which a non-standard sector size is applied.

This work was supported by Institute of Information & communications Technology Planning & Evaluation (IITP) grant funded by the Korea government (Ministry of Science and ICT) (Project unique No.: 1711193550; Project No.: 2021-0-00863-003; R&D project: Development of new concept PIM semiconductor technology; Research Project Title: Development of an Intelligent In-Memory Error Correction Device for High-Reliability Memory; and Project period: 2024.01.01.˜2024.12.31.), National Research Foundation of Korea (NRF) grant funded by the Korea government (Ministry of Science and ICT) (Project unique No.: 1711191430; Project No.: 2020M3H2A1076786; R&D project: System Semiconductor Convergence Professional Training Program (Phase 2, Part ½); Research Project Title: Industry-Academia Collaboration IoT Semiconductor System Convergence Human Resource Development Center; and Project period: 2024.01.01.˜2024.12.31.), and Institute of Information & communications Technology Planning & Evaluation (IITP) grant funded by the Korea government (Ministry of Science and ICT) (Project unique No.: 1711193231; Project No.: 2019-0-00421-005; R&D project: Information, Communication, and Broadcasting Innovation Talent Development; Research Project Title: Artificial Intelligence Graduate School Support (Sungkyunkwan University); and Project period: 2024.01.01.˜2024.12.31.).

### BACKGROUND

In-band ECC used in GPUs equipped with GDDR transmits data and its corresponding ECC redundancy over the same data channel. This allows the integration of error correction functionality without additional hardware modifications, but this can lead to increased bandwidth usage. That is, in the conventional In-band ECC method, detecting and correcting memory errors requires additional memory access to handle both the ECC redundancy and the data, resulting in GPU performance degradation.

### SUMMARY

An object of the present invention is to provide a technology capable of processing data and its corresponding ECC redundancy in a single memory access by maintaining the cache line size in sector cache of a GPU while adjusting the cache sector size to a byte size that is not a power of two.

According to one aspect of the present invention, a processor includes a memory controller and a cache memory, wherein the memory controller, during a write operation to a main memory, generates a B-byte sized parity for A-byte sized data, stores the A-byte sized data and the B-byte sized parity through a single write command, and during a read operation from the main memory, reads the A-byte sized data and the B-byte sized parity through a single read command, performs error correction on the A-byte sized data based on the B-byte sized parity, and then transfers only the A-byte sized data from among the A-byte sized data and the B-byte sized parity to the cache memory.

The cache memory may receive the A-byte sized data from the memory controller or transmits the A-byte sized data to the memory controller, and includes at least one cache line that stores a plurality of the A-byte sized data.

The A-byte sized data may not be a power of two, and the sum of the A-byte size and the B-byte size may be a power of two.

The A-byte size may be 30 bytes, and the B-byte size may be 2 bytes.

The cache memory may include a plurality of cache lines, wherein each of the plurality of cache lines stores M units of the A-byte sized data and N units of C-byte sized data, and wherein the C-byte size may be different from the A-byte size.

M may be 4, N may be 1, the A-byte size may be 30 bytes, the B-byte size may be 2 bytes, and C may be 8.

The main memory may be an external DRAM memory.

The main memory may be a memory that uses a 32-byte size as its data transfer unit.

According to another aspect of the present invention, a processor includes a memory controller and a cache memory, wherein the memory controller, during a write operation to the main memory, stores A-byte sized data and B-byte sized metadata for the A-byte sized data through a single write command, and during a read operation from the main memory, reads the A-byte sized data and the B-byte sized metadata through a single read command, and transfers only the A-byte sized data from among the A-byte sized data and the B-byte sized metadata to the cache memory, and the cache memory receives the A-byte sized data from the memory controller or transmits the A-byte sized data to the memory controller, and includes at least one cache line that stores a plurality of the A-byte sized data.

According to still another aspect of the present invention, a GPU includes: a cache including at least one cache line that includes a plurality of cache sectors having a size of 2^{m}-K bytes; a GDDR memory including a plurality of memory sectors having a size of 2^{m} bytes; and a memory controller that controls the GDDR memory to store, during a write operation to the GDDR memory, first data of 2^{m}-K byte size received from an external memory and first ECC redundancy of K-byte size corresponding to the first data in a first memory sector among the plurality of memory sectors.

The memory controller may include an ECC module that performs error correction on the first data based on the first ECC redundancy during a read operation on the GDDR memory.

The memory controller may control the GDDR memory to, during a read operation on the GDDR memory, transmit the first data stored in the first memory sector, on which error correction has been performed, to a first cache sector among the plurality of cache sectors.

2^{m}-K may be 30, and K may be 2.

According to further aspect of the present invention, a GPU includes: a first cache including at least one cache line that includes a plurality of cache sectors having a size of 2^{m}-K bytes; a plurality of streaming multiprocessors that share the first cache, each including a second cache; a GDDR memory including a plurality of memory sectors having a size of 2^{m} bytes; and a memory controller that controls the GDDR memory to store, during a write operation to the GDDR memory, first data of 2^{m}-K byte size and first ECC redundancy of K-byte size corresponding to the first data in a first memory sector among the plurality of memory sectors.

According to still further aspect of the present invention, a method for operating a GPU including a cache that includes at least one cache line including a plurality of cache sectors having a size of 2^{m}-K bytes, a GDDR memory including a plurality of memory sectors having a size of 2^{m} bytes, and a memory controller includes: transmitting a write command for the GDDR memory to the GDDR memory; and storing first data of 2^{m}-K byte size and first ECC redundancy of K-byte size corresponding to the first data in a first memory sector among the plurality of memory sectors.

According to yet another aspect of the present invention, a method for operating a GPU including a first cache that includes at least one cache line including a plurality of cache sectors having a size of 2^{m}-K bytes, a plurality of streaming multiprocessors that share the first cache and each include a second cache, a GDDR memory including a plurality of memory sectors having a size of 2^{m} bytes, and a memory controller includes: transmitting a write command for the GDDR memory to the GDDR memory; and storing first data of 2^{m}-K byte size and first ECC redundancy of K-byte size corresponding to the first data in a first memory sector among the plurality of memory sectors.

According to above aspects of the present invention, the performance and energy efficiency of a GPU may be improved by reducing the number of memory accesses and optimizing bandwidth usage while maintaining the memory protection function.

### BRIEF DESCRIPTION OF THE DRAWINGS

FIG. 1 is a block diagram illustrating a GPU according to an embodiment of the present invention.

FIG. 2 is a flowchart illustrating a GPU operating method according to an embodiment of the present invention.

FIGS. 3, 4, 5, and 6 are diagrams illustrating a conventional GPU to which In-band ECC is applied.

FIGS. 7, 8, 9, and 10 are diagrams illustrating the operation of the GPU shown in FIG. 1 according to an embodiment of the present invention.

FIGS. 11 and 12 are diagrams illustrating specific details for implementing a GPU according to an embodiment of the present invention.

### DETAILED DESCRIPTION

The advantages and features of the present invention, and methods for achieving them, will become clear by referring to the embodiments described in detail below with reference to the accompanying drawings. However, the present invention is not limited to the embodiments disclosed hereinafter but may be implemented in various forms. These embodiments are provided only to make the disclosure of the present invention complete and to fully inform a person of ordinary skill in the art to which the present invention pertains of the scope of the invention, and the scope of the present invention is defined only by the claims.

In describing the embodiments of the present invention, detailed descriptions of known functions or configurations will be omitted except when actually necessary for explaining the embodiments of the present invention. Also, the terms described below are terms defined in consideration of their functions in the embodiments of the present invention, and may vary depending on the user's or operator's intention or customs. Therefore, their definitions should be made based on the content throughout this specification.

Hereinafter, terms such as ‘. . . unit’, ‘. . . device’, etc., refer to a unit that processes at least one function or operation, and this may be implemented as hardware, software, or a combination of hardware and software.

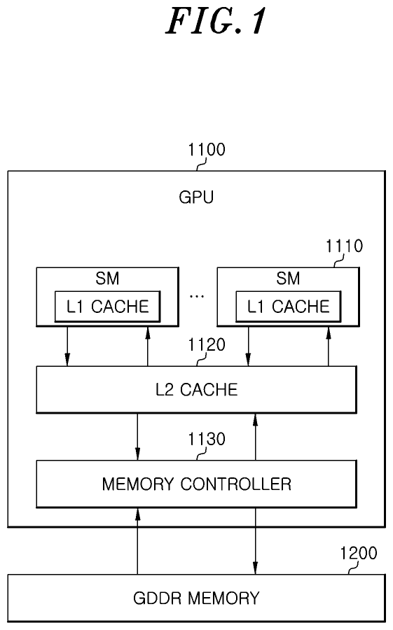

FIG. 1 is a block diagram illustrating a GPU according to an embodiment of the present invention.

Referring to FIG. 1, a GPU 1100 according to an embodiment of the present invention may include a plurality of Streaming Multiprocessors (SMs) 1110 including an L1 cache, an L2 cache 1120, a memory controller 1130, and a GDDR memory 1200.

The plurality of Streaming Multiprocessors 1110 may perform operations on data stored in the L1 cache, respectively, to process parallel tasks.

The L1 cache may fetch and store data to be processed by each Streaming Multiprocessor 1110 from the L2 cache 1120. The L1 cache may include at least one cache line, and each cache line may include a plurality of sectors. At this time, the L1 cache may sequentially store the data to be processed by the Streaming Multiprocessor 1110 starting from the space of the first sector.

In an embodiment, the size of each sector of the L1 cache may be 2^{m}-K (e.g., 30, 29, 28, . . . ) bytes. Specifically, if each cache line of the L1 cache includes four sectors, the size of each sector is 32 bytes, and the ECC redundancy for 30-byte sized data has a size of 2 bytes, the L1 cache may sequentially store data of 128-30×4 byte size starting from the space of the first cache sector of the first cache line.

In an embodiment, the L1 cache may include at least one cache line including a plurality of cache sectors having a size of 2^{m}-K bytes.

The L2 cache 1120 is a cache shared by the Streaming Multiprocessors 1110. It may read and store data to be processed in parallel by the Streaming Multiprocessors 1110 from the GDDR memory 1200, and the stored data may be transferred to each L1 cache. The L2 cache 1120 includes at least one cache line, and each cache line may include a plurality of cache sectors.

In an embodiment, the size of each sector of the L2 cache 1120 may be 2^{m}-K (e.g., 30, 29, 28, . . . ) bytes. Specifically, if each cache line of the L2 cache 1120 includes four sectors, the size of each sector is 32 bytes, and the ECC redundancy for 30-byte sized data has a size of 2 bytes, the L2 cache 1120 may sequentially store data of 128-30×4 byte size starting from the space of the first cache sector of the first cache line.

In an embodiment, the L2 cache may include at least one cache line including a plurality of cache sectors having a size of 2^{m}-K bytes and an ECC cache sector having a size of M×K bytes.

Furthermore, the L1 cache and/or the L2 cache may receive A-byte sized data from the memory controller or transmit A-byte sized data to the memory controller, and may include at least one cache line that stores a plurality of A-byte sized data.

In an embodiment, the A-byte sized data is not a power of two, and the sum of the A-byte size and a B-byte size may be a power of two.

In an embodiment, the A-byte size may be 30 bytes, and the B-byte size may be 2 bytes.

In an embodiment, the cache memory includes a plurality of cache lines, wherein each of the plurality of cache lines stores M units of the A-byte sized data and N units of C-byte sized data, and the C-byte size may be different from the A-byte size.

In an embodiment, M may be 4, N may be 1, the A-byte size may be 30 bytes, the B-byte size may be 2 bytes, and C may be 8.

In an embodiment, the main memory may be a DRAM memory external to the GPU 1100.

In an embodiment, the main memory may be a memory that uses a 32-byte size as its data transfer unit.

The memory controller 1130 may control a write operation to the GDDR memory 1200. Specifically, the memory controller 1130, during a write operation to the GDDR memory 1200, may read data from a cache line of the GPU 1100 according to a cache policy and store it in the GDDR memory 1200.

In an embodiment, the memory controller 1130, during a write operation to the GDDR memory 1200, may control the GDDR memory 1200 to store data and ECC redundancy corresponding to the data in the GDDR memory 1200.

Furthermore, the memory controller 1130 may control a read operation on the GDDR memory 1200. Specifically, the memory controller 1130, during a read operation on the GDDR memory 1200, may transmit data of 2^{m}-K byte size stored in each of the 0th to Kth memory sectors among a plurality of memory sectors included in the GDDR memory 1200 to the area of the 0th to Kth cache sectors among a plurality of cache sectors.

In an embodiment, the memory controller 1130 may control the GDDR memory to store first data of 2^{m}-K byte size and first ECC redundancy of M-byte size corresponding to the first data in a first memory sector among the plurality of memory sectors during a write operation to the GDDR memory.

Furthermore, the memory controller 1130 may include an ECC module for performing error correction on data read from the GDDR during a read operation on the GDDR memory 1200. The ECC module may perform error correction on the 2^{m}-K byte sized data using the K-byte sized ECC redundancy.

In an embodiment, the memory controller 1130, during a read operation on the GDDR memory, may control the GDDR memory to transmit the first data stored in the first memory sector to a first cache sector among the plurality of cache sectors and transmit the first ECC redundancy to an ECC cache sector.

Furthermore, the memory controller 1130, during a write operation to the main memory, generates a B-byte sized parity for A-byte sized data, stores the A-byte sized data and the B-byte sized parity through a single write command, and during a read operation from the main memory, reads the A-byte sized data and the B-byte sized parity through a single read command, performs error correction on the A-byte sized data based on the B-byte sized parity, and then transfers only the A-byte sized data from among the A-byte sized data and the B-byte sized parity to the cache memory.

Furthermore, the memory controller 1130, during a write operation to the main memory, stores A-byte sized data and B-byte sized metadata for the A-byte sized data through a single write command, and during a read operation from the main memory, reads the A-byte sized data and the B-byte sized metadata through a single read command, and transfers only the A-byte sized data from among the A-byte sized data and the B-byte sized metadata to the cache memory.

The GDDR memory 1200 includes a plurality of banks connected in parallel, each bank includes a plurality of pages, and each page may include a plurality of memory sectors.

Furthermore, the GPU 1100 may include at least one data channel for transmitting data stored in the GDDR memory 1200 to each cache sector of the L2 cache 1120.

Furthermore, the GPU 1100 in FIG. 1 is merely an example for aiding understanding of the present invention, and it is apparent that any processor that processes data can be applied in the same manner as the GPU 1100 of the present invention.

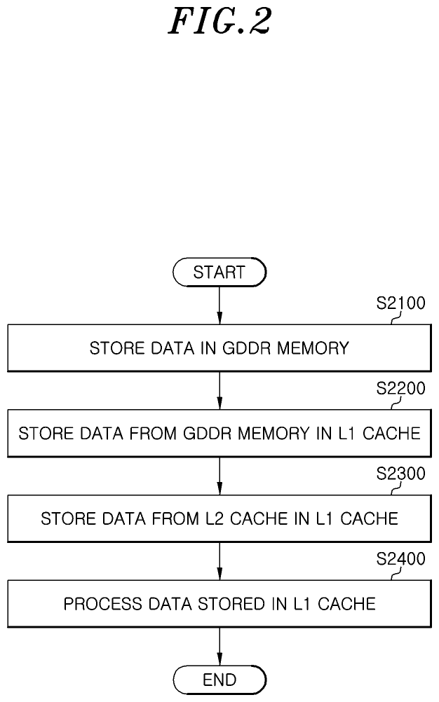

FIG. 2 is a flowchart illustrating a GPU operating method according to an embodiment of the present invention.

Hereinafter, the method will be described by way of example as being performed by the GPU 1100 shown in FIG. 1.

In step S2100, the GPU 1100 may store data and its corresponding ECC redundancy in the GDDR memory 1200.

In an embodiment, the GPU 1100 may store 2^{m}-K byte sized data and M-byte sized ECC redundancy in each memory sector of the GDDR memory 1200. Here, the size of the memory sector may be 2^{m} bytes.

In step S2200, the GPU 1100 may store the data and ECC redundancy stored in the GDDR memory 1200 in the L2 cache 1120.

In an embodiment, the GPU 1100 may store the 2^{m}-K byte sized data stored in each of the 0th to Kth memory sectors among the plurality of memory sectors included in the GDDR memory 1200 in the area of the 0th to Kth cache sectors among the plurality of cache sectors.

Furthermore, the CPU may perform error correction on the 2^{m}-K byte sized data using the M-byte sized ECC redundancy to verify the data read from the GDDR.

In step S2300, the GPU 1100 may read the data to be processed by each of the plurality of Streaming Multiprocessors 1110 from the L2 cache 1120 and store it in the L1 cache.

In step S2400, the GPU 1100 may process the data stored in each L1 cache using the plurality of Streaming Multiprocessors 1110.

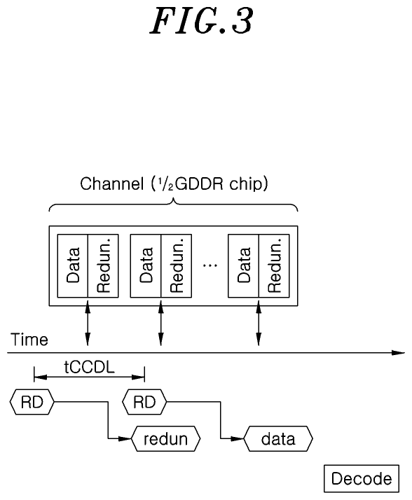

FIGS. 3 to 6 are diagrams illustrating a conventional GPU to which In-band ECC is applied.

Referring to FIG. 3, each memory sector in a GDDR memory 1200 (chip) may include data (Data) and its corresponding ECC redundancy (Redun.). In this case, during a read operation, the GPU first transmits a read command (RD) for the ECC redundancy to the GDDR memory to read the ECC redundancy (Redun.). After a time tCCDL, the GPU transmits a read command (RD) for the data corresponding to the ECC redundancy to the GDDR memory to read the data. The GPU can perform error correction on the data based on the ECC redundancy to verify errors in the GDDR memory, whether the stored data is erroneous, and so on.

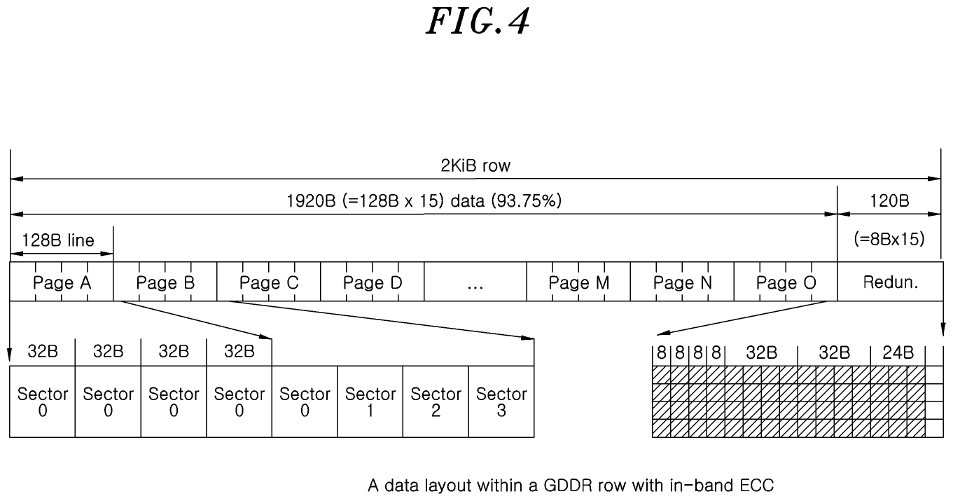

Referring to FIG. 4, the structure of a GDDR memory is shown where one row has a size of 2Ki bytes. In one row, 1920 (128×15) bytes of data are stored, and 120 bytes of ECC redundancy can be stored. Here, the data storage efficiency is 93.75%. Each row consists of 16 pages. Data is stored from the first page (Page A) to the 15th page (Page O), and the 16th page may store the ECC redundancy (Rddun) corresponding to the data stored from the first page (Page A) to the 15th page (Page O). Furthermore, each page may include four memory sectors (Sector), each having a size of 32 bytes.

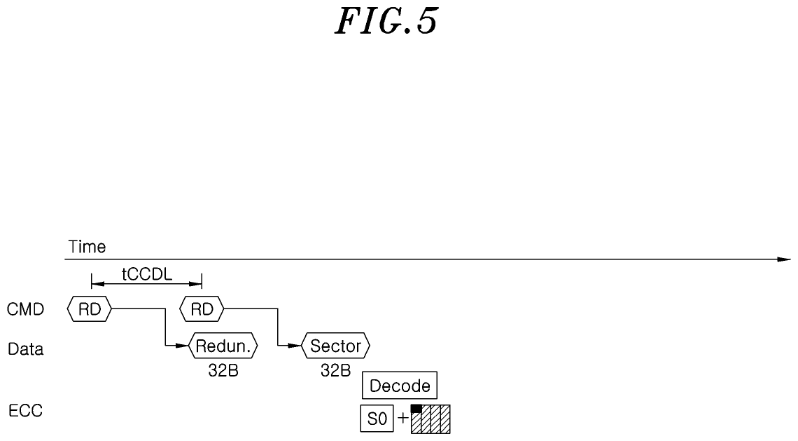

Referring to FIG. 5, when a GPU intends to process data (32-byte size) stored in one memory sector of the GDDR memory, it transmits a first read command (RD) to the GDDR memory to read all the ECC redundancy (32-byte size) stored in the memory sector where the ECC redundancy (8-byte size) corresponding to the target data is stored. After a time tCCDL, the GPU transmits a second read command (RD) to the GDDR memory to read the target data (32-byte size). The GPU can perform error correction on the target data (32-byte size) using the ECC redundancy (8-byte size) corresponding to the target data (32-byte size) from among the 32-byte sized ECC redundancy.

In this case, even to process data stored in a single memory sector, two accesses to the GDDR memory are required, which can lead to problems of bandwidth and time delay.

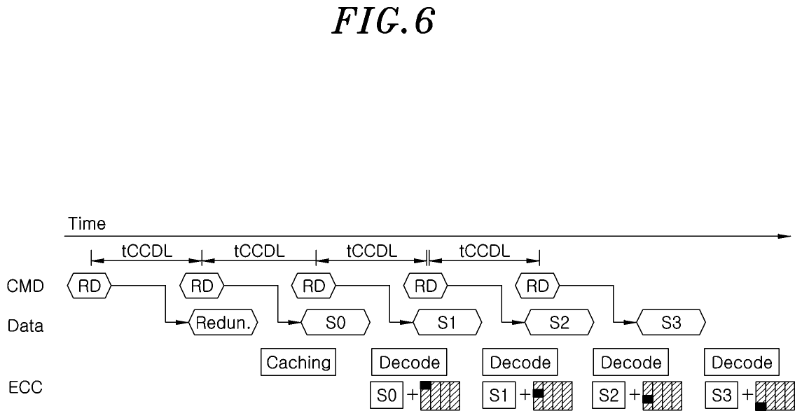

Referring to FIG. 6, when a GPU intends to process data (32×4 byte size) stored in four memory sectors with consecutive addresses, it transmits a first read command (RD) to the GDDR memory to read all the ECC redundancy (8×4 byte size) stored in the memory sector where the ECC redundancy (8×4 byte size) corresponding to the target data is stored. After a time tCCDL, the GPU transmits second to fourth read commands (RD) at tCCDL time intervals to sequentially read the data (32-byte size) stored in each memory sector at each time interval. The GPU can perform error correction on the data read from each memory sector based on its corresponding ECC redundancy.

In this case, if the addresses of the four memory sectors where the 32×4 byte sized data is stored are not consecutive, read operations on two or more memory sectors may be required to read the ECC redundancy, which can cause problems of bandwidth and time delay.

Therefore, in the present invention, to resolve these problems of bandwidth and time delay, a method of storing data and ECC redundancy together in a single memory sector is proposed.

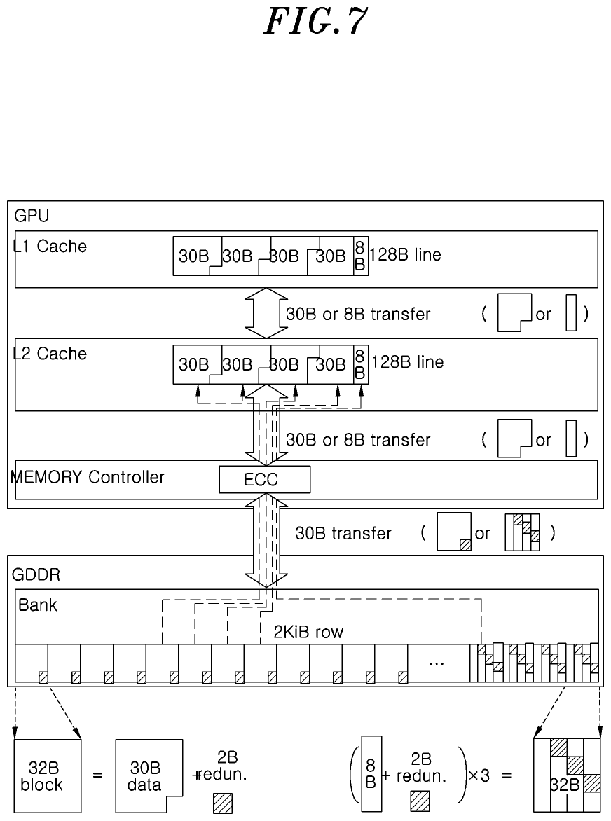

FIGS. 7 to 10 are diagrams illustrating the operation of the GPU shown in FIG. 1 according to an embodiment of the present invention.

Referring to FIG. 7, in the GDDR memory 1200, each memory sector (block) has a storage space of 2n byte size (32-byte size), and can store data (data) of 2^{m}-K byte size (e.g., 30-byte size or 8-byte size) and its corresponding ECC redundancy (redun) of M-byte size (2-byte size).

When the GPU 1100 intends to process data stored in the 5th to 8th memory sectors, it reads the data and ECC redundancy from each of the 5th to 8th memory sectors through the same channel. In this process, the GPU 1100 can perform error correction on the data read from the GDDR memory 1200. The GPU 1100 may sequentially store the data read from the GDDR memory 1200 in the first to fourth cache sectors of the L2 cache 1120, and store the ECC redundancies in the last cache sector. The GPU 1100 may transmit the data and ECC redundancy stored in the L2 cache 1120 to the cache line of the L1 cache included in each of the plurality of Streaming Multiprocessors 1110, and each Streaming Multiprocessor 1110 can process the data stored in each L1 cache.

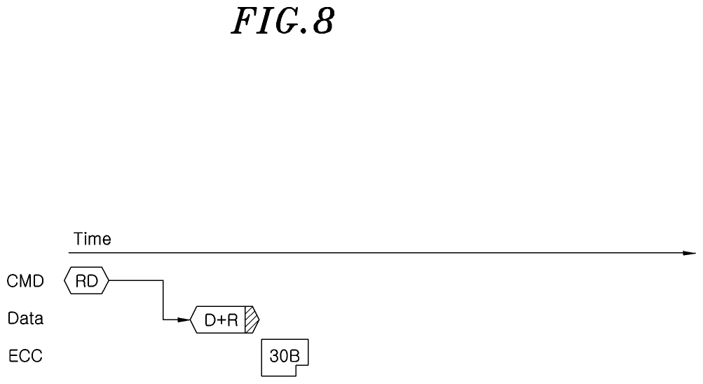

Referring to FIG. 8, an example is shown where the GPU 1100 processes data of a size smaller than the size of one cache sector (or memory sector) (e.g., 32-byte size). The GPU 1100 transmits a single read command (RD) to the GDDR memory 1200 to read the data (D) and ECC redundancy (R) stored in one memory sector where the target data of the GDDR memory 1200 is stored, through the same channel. The GPU 1100 can perform error correction on the data (D) using the read ECC redundancy (R).

Therefore, in the GPU 1100 according to an embodiment of the present invention, unlike the conventional GPU shown in FIG. 5, a separate read command and time tCCDL for reading the ECC redundancy are not required, so it can have an improved effect in terms of bandwidth and latency.

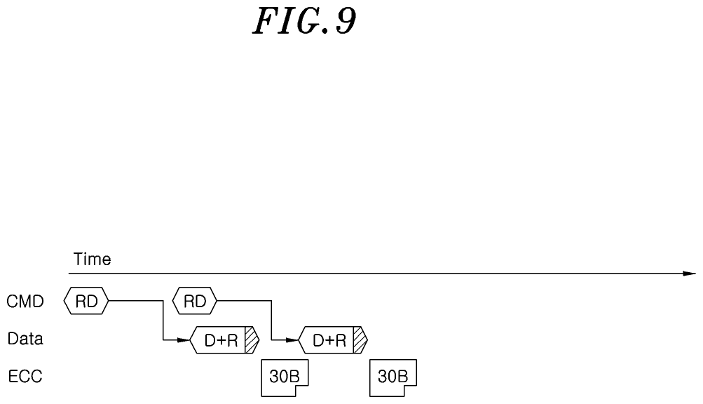

Referring to FIG. 9, an example is shown where the GPU 1100 processes data larger than the size of one cache sector (or memory sector) (e.g., 32-byte size) and smaller than the size of two cache sectors (or memory sectors) (e.g., 64-byte size). The GPU 1100 transmits a first read command (RD) to the GDDR memory 1200 to read the data (D) and ECC redundancy (R) stored in a first memory sector, and can perform error correction on the data (D) using the read ECC redundancy (R). The GPU 1100 transmits a second read command (RD) to the GDDR memory 1200 to read the data (D) and ECC redundancy (R) stored in a second memory sector, and can perform error correction on the data (D) using the read ECC redundancy (R).

Therefore, in the GPU 1100 according to an embodiment of the present invention, unlike the conventional GPU shown in FIG. 5 which must perform read commands on two memory sectors where data is stored and at least one memory sector where ECC redundancy is stored, it only performs read commands on the two memory sectors where data and ECC redundancy are stored, so it can have an improved effect in terms of bandwidth and latency.

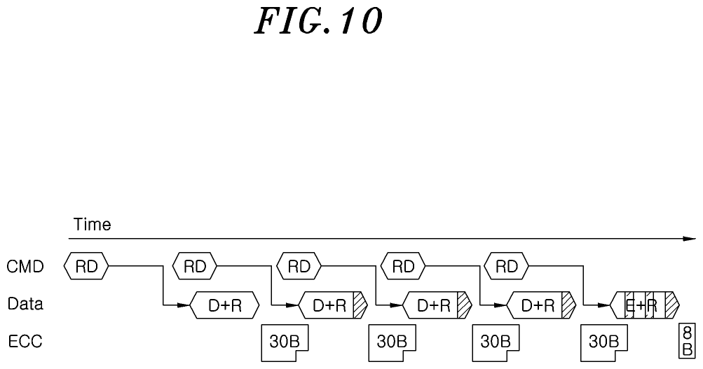

Referring to FIG. 10, an example is shown where the GPU 1100 processes data of the size of one cache line (e.g., 128-byte size). The target data is stored such that data of 2^{m}-K byte size (e.g., 30-byte size) is stored in each of the first to fourth memory sectors of the GDDR memory 1200, and the remaining K-byte sized (e.g., 2-byte size) data is stored in a fifth memory sector. The GPU 1100 sequentially transmits first to fifth read commands (RD) to the GDDR memory 1200 to read the data (D) and ECC redundancy (R) stored in each of the first to fifth memory sectors. At this time, the GPU 1100 can perform error correction on the data (D) using the ECC redundancy (R) read from each of the first to fifth memory sectors.

At this time, it can be confirmed that the GPU 1100 according to an embodiment of the present invention performs the same number of read commands and read operations on the GDDR memory 1200 as the conventional GPU shown in FIG. 6, so no performance degradation occurs in terms of bandwidth and latency compared to the conventional GPU.

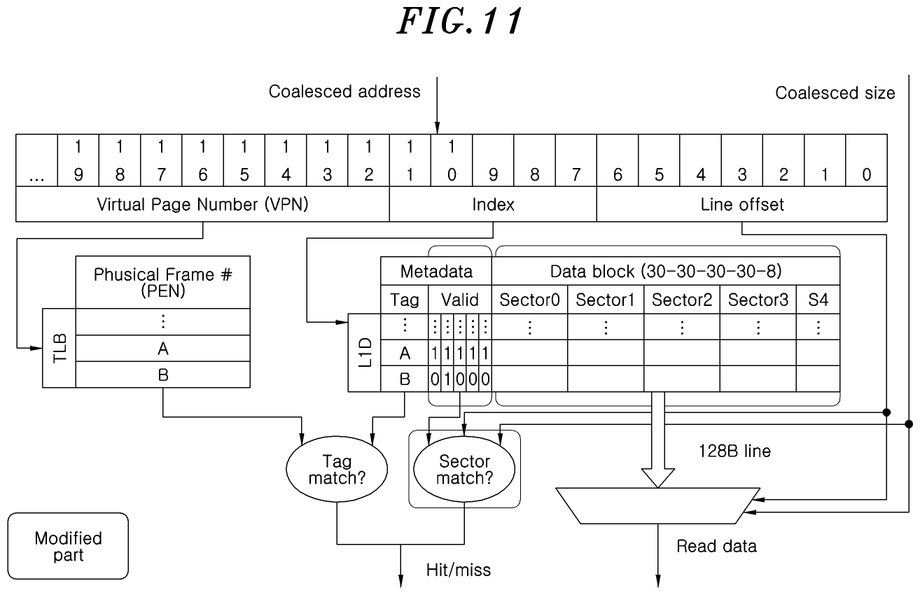

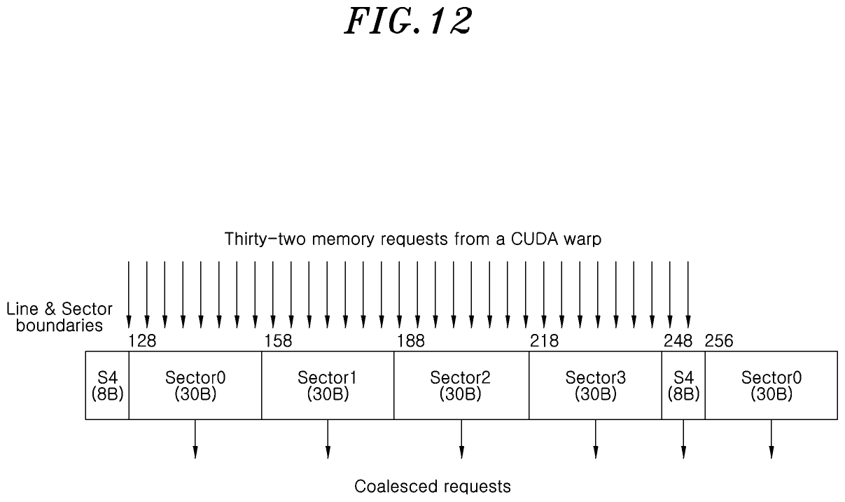

FIGS. 11 and 12 are diagrams illustrating specific details for implementing a GPU according to an embodiment of the present invention.

To implement the GPU 1100 according to an embodiment of the present invention, the main change to be applied to a conventional GPU, as shown in FIG. 11, is to extend the valid bit vector in the tag array of all data caches from four bits to five bits. This change is necessary to manage the additional sector introduced by the cache line reconfigured by CacheCraft. The hit/miss logic within each cache is also updated to match the modified valid bit vector, enabling accurate determination of data availability based on the new sector layout. Despite the sector change, the logical structure of the SRAM data array is maintained at 128 bytes, but the internal cache operation is adjusted to fit the new sectoring scheme.

Furthermore, as shown in FIG. 12, in an embodiment of the present invention, the memory coalescer is adapted to a new sector configuration subdivided into 30 B-30 B-30 B-30 B-8 B, departing from the traditional 32 B-32 B-32 B-32 B sectoring configuration.

However, this reconfiguration may be accompanied by some challenges. First, the reduction in sector size can increase the number of coalesced requests (e.g., from 4 to 5), which can increase serialization overhead within the memory pipeline. To address this, in the present invention, an additional port is connected to the interface between the coalescer and the L1 cache.

Furthermore, the unique sector size causes memory requests to span the boundary of two sectors. In the existing scheme, each 32 B sector perfectly aligns with the data size (1 B/2 B/4 B/8 B/16 B), but a 30 B sector may not. In the case of an unaligned access, CacheCraft's coalescer requests two adjacent sectors to ensure all data necessary for processing is available. An SM using the Single Instruction, Multiple Thread (SIMT) execution model waits until all data requested from a warp has arrived, thereby allowing the system to handle such unaligned accesses smoothly and efficiently.

Furthermore, the 30-30-30-30-8 layout described above has the effect of reducing memory access and improving bandwidth reduction for the same data capacity and reliability level compared to the existing method.

In addition to this, it can be utilized in various embodiments including layouts such as 29-29-29-29-12, 28-28-28-28-16, and in these cases, it is apparent that it can be utilized in a way that achieves a higher level of reliability from data-redundancy ratios of 29:3 and 28:4, respectively, at the slight expense of data capacity and the improved bandwidth reduction.

The apparatus described above may be implemented with hardware components, software components, and/or a combination of hardware components and software components. For example, the apparatuses and components described in the embodiments may be implemented using one or more general-purpose computers or special-purpose computers, such as, for example, a processor, a controller, an arithmetic logic unit (ALU), a digital signal processor, a microcomputer, a field programmable array (FPA), a programmable logic unit (PLU), a microprocessor, or any other device capable of executing instructions and responding. The processing device may execute an operating system (OS) and one or more software applications running on the operating system.

Furthermore, the processing device may respond to the execution of software to access, store, manipulate, process, and generate data. For ease of understanding, although it may be described that one processing device is used, a person of ordinary skill in the art will understand that the processing device may include a plurality of processing elements and/or a plurality of types of processing elements. For example, the processing device may include a plurality of processors or one processor and one controller. Furthermore, other processing configurations, such as a parallel processor, are also possible.

Software may include a computer program, code, instructions, or a combination of one or more thereof, and may configure the processing device to operate as desired or command the processing device independently or collectively. Software and/or data may be permanently or temporarily embodied in any type of machine, component, physical device, virtual equipment, computer storage medium or device, or transmitted signal wave to be interpreted by the processing device or to provide commands or data to the processing device. The software may be distributed over networked computer systems and may be stored or executed in a distributed manner. The software and data may be stored on one or more computer-readable recording media.

The above description is merely illustrative of the technical idea of the present invention, and various modifications and variations will be possible for those of ordinary skill in the art to which the present invention pertains without departing from the essential quality of the present invention. Therefore, the embodiments disclosed in this specification are not for limiting the technical idea of the present invention but for explaining it, and the scope of the technical idea of the present invention is not limited by these embodiments. The scope of protection of the present invention should be interpreted by the following claims, and all technical ideas within the equivalent scope thereof should be interpreted as being included in the scope of rights of the present invention.

What is claimed is:

1. A processor, comprising a memory controller and a cache memory,
wherein the memory controller:
during a write operation to a main memory, generates a B-byte sized parity for A-byte sized data, and stores the A-byte sized data and the B-byte sized parity through a single write command, and
during a read operation from the main memory, reads the A-byte sized data and the B-byte sized parity through a single read command, performs error correction on the A-byte sized data based on the B-byte sized parity, and then transfers only the A-byte sized data from among the A-byte sized data and the B-byte sized parity to the cache memory, and
wherein the cache memory:
receives the A-byte sized data from the memory controller or transmits the A-byte sized data to the memory controller, and
includes at least one cache line that stores a plurality of a A-byte sized data.

2. The processor of claim 1, wherein the A-byte sized data is not a power of two, and
wherein the sum of the A-byte size and the B-byte size is a power of two.

3. The processor of claim 1, wherein the A-byte size is 30 bytes, and
wherein the B-byte size is 2 bytes.

4. The processor of claim 1, wherein the cache memory includes a plurality of cache lines,
wherein each of the plurality of cache lines stores M units of the A-byte sized data and N units of C-byte sized data, and
wherein the C-byte size is different from the A-byte size.

5. The processor of claim 4, wherein the M is 4, the N is 1, the A-byte size is 30 bytes, the B-byte size is 2 bytes, and the C is 8.

6. The processor of claim 1, wherein the main memory is an external DRAM memory.

7. The processor of claim 1, wherein the main memory is a memory that uses a 32-byte size as its data transfer unit.

8. A processor, comprising a memory controller and a cache memory,
wherein the memory controller:
during a write operation to a main memory, stores A-byte sized data and B-byte sized metadata for the A-byte sized data through a single write command, and
during a read operation from the main memory, reads the A-byte sized data and the B-byte sized metadata through a single read command, and transfers only the A-byte sized data from among the A-byte sized data and the B-byte sized metadata to the cache memory, and
wherein the cache memory:
receives the A-byte sized data from the memory controller or transmits the A-byte sized data to the memory controller, and
includes at least one cache line that stores a plurality of the A-byte sized data.

9. The processor of claim 8, wherein the A-byte sized data is not a power of two, and wherein the sum of the A-byte size and the B-byte size is a power of two.

10. The processor of claim 8, wherein the A-byte size is 30 bytes, and
wherein the B-byte size is 2 bytes.

11. The processor of claim 8, wherein the cache memory includes a plurality of cache lines,
wherein each of the plurality of cache lines stores M units of the A-byte sized data and N units of C-byte sized metadata, and
wherein the C-byte size is different from the A-byte size.

12. The processor of claim 11, wherein the M is 4, the N is 1, the A-byte size is 30 bytes, the B-byte size is 2 bytes, and the C is 8.

13. The processor of claim 8, wherein the main memory is an external DRAM memory.

14. The processor of claim 8, wherein the main memory is a memory that uses a 32-byte size as its data transfer unit.

15. A GPU (Graphics Processing Unit), comprising:
a cache including at least one cache line that includes a plurality of cache sectors having a size of 2^{m}-K bytes;
a GDDR memory including a plurality of memory sectors having a size of 2^{m} bytes; and
a memory controller that controls the GDDR memory to store, during a write operation to the GDDR memory, first data of 2^{m}-K byte size and first ECC redundancy of K-byte size corresponding to the first data in a first memory sector among the plurality of memory sectors.
